(19) United States
(12) Patent Application Publication
(10) Pub. No.: US 2013/0026668 A1
(43) Pub. Date: Jan. 31, 2013

(54) LENS MOLDING APPARATUS AND LENS MOLDING METHOD USING THE SAME

(71) Applicants: Kwang Chun LEE, Suwon (KR); Young Su Jin, Suwon (KR); Sang Hyo Seo, Suwon (KR)

(72) Inventors: Kwang Chun LEE, Suwon (KR); Young Su Jin, Suwon (KR); Sang Hyo Seo, Suwon (KR)

(73) Assignee: SAMSUNG ELECTRO-MECHANICS CO., LTD., Suwon (KR)

(21) Appl. No.: 13/525,826

(22) Filed: Jun. 18, 2012

(30) Foreign Application Priority Data
Jul. 28, 2011 (KR) 10-2011-0075085

(51) Int. Cl. B29C 33/30; B29D 11/00

(52) U.S. Cl. 264/1.1; 425/150

(57) ABSTRACT

There is provided a lens molding apparatus, the apparatus including: a first mold part and a second mold part molding a lens array; first alignment marks respectively formed on the first mold part and the second mold part; second alignment marks respectively formed on the first mold part and the second mold part and positioned outside of the first alignment marks; and a controller sensing an alignment error of the first alignment marks based on the second alignment marks and correcting a relative position of the second mold part with respect to the first mold part in proportion to the magnitude of the sensed alignment error.

### CROSS-REFERENCE TO RELATED APPLICATIONS

This application claims the priority of Korean Patent Application No. 10-2011-0075085 filed on Jul. 28, 2011, in the Korean Intellectual Property Office, the disclosure of which is incorporated herein by reference.

### BACKGROUND OF THE INVENTION

1. Field of the Invention

The present invention relates to a lens molding apparatus and a lens molding method using the same, and more particularly, to a lens molding apparatus and a lens molding method using the same, capable of improving a degree of molding precision in molding a plurality of lenses included in a lens array.

2. Description of the Related Art

A molded lens formed of a plastic material, as part of an optical device used in a camera or a camera of a mobile phone, has been come into widespread use. This plastic molded lens is cheaper than a polished glass lens in view of lens manufacturing costs, and may be easily manufactured to have an aspherical shape. Further, a plastic molded lens may be manufactured in an array scheme, and thus has strengths in terms of mass production.

In general, a plastic molded lens is manufactured through an array scheme. That is, the plastic molded lens is manufactured by using a lens material (which may contain a resin) received in a mold and being aligned between molds.

The mold may have a plurality of lens molding parts for molding lenses for a lens array, and may include a stationary mold part in which the lens material is received and a movable mold part to be aligned therewith with respect to the lens material received in the stationary mold part.

Here, in order to improve the degree of molding precision of the lens array, the alignment position of the movable mold part with respect to the stationary mold part needs to be within a predetermined margin of error. In the related art, alignment marks are respectively formed on the stationary mold part and the movable mold part, and the alignment position of the movable mold part is corrected based on these alignment marks.

However, since alignment marks formed on the molds have the same level of reflectance as the lens material and are covered with the lens material while the molds are aligned with each other with respect to the lens material received in the mold to form lens, the final alignment position of the movable mold part may be wrong. In this case, the entire molded lenses of a lens array may be determined to be defective.

Therefore, a need exists for the development of a lens molding apparatus and a lens molding method using the same, capable of improving yield in the production of lenses and lens arrays.

### SUMMARY OF THE INVENTION

An aspect of the present invention provides a lens molding apparatus and a lens molding method using the same, capable of precisely correcting or adjusting alignment positions of a stationary mold part and a movable mold part.

According to an aspect of the present invention, there is provided a lens molding apparatus, the apparatus including: a first mold part and a second mold part molding a lens array; first alignment marks respectively formed on the first mold part and the second mold part; second alignment marks respectively formed on the first mold part and the second mold part and positioned outside of the first alignment marks; and a controller sensing an alignment error of the first alignment marks based on the second alignment marks and correcting a relative position of the second mold part with respect to the first mold part in proportion to the magnitude of the sensed alignment error.

The first mold part or the second mold part may have a receiving region in which a lens material for aligning the lens array is received.

The second alignment marks may be formed outside of the receiving region to prevent an encroachment thereon by the lens material.

The second alignment marks may be formed on lateral surfaces of the first mold part and the second mold part.

The apparatus may further include a position corrector moving the first mold part or the second mold part in response to a control signal from the controller.

The apparatus may further include a first sensor and a second sensor sensing a match or mismatch between the first alignment marks and the second alignment marks, respectively.

According to another aspect of the present invention, there is provided a lens molding method, the method including: allowing a first mold part and a second mold part to be aligned with each other and thus allowing first alignment marks respectively formed on the first mold part and the second mold part to be matched with one another; inspecting whether the second alignment marks respectively formed on the first mold part and the second mold part are matched with one another, and then measuring the degree of mismatch (error) of the second alignment marks; correcting a alignment position of the first mold part or the second mold part in proportion to the magnitude of the measured error; and re-aligning the first mold part and the second mold part and hardening a lens material.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a lens molding apparatus according to an embodiment of the present invention;

FIG. 2 is an enlarged view of Part A shown in FIG. 1;

FIG. 3 is a flow chart for explaining a lens molding method using the lens molding apparatus shown in FIG. 1;

FIG. 4 is a cross-sectional view of a lens molding apparatus according to another embodiment of the present invention;

FIG. 5 is a cross-sectional view of a lens molding apparatus according to another embodiment of the present invention; and

FIG. 6 is a cross-sectional view of a lens molding apparatus according to another embodiment of the present invention.

### DETAILED DESCRIPTION OF THE EMBODIMENTS

Hereinafter, embodiments of the present invention will be described in detail with reference to the accompanying drawings.

In describing the present invention below, terms indicating components of the present invention are named in consideration of functions of each component. Therefore, the terms should not be understood as being limited to technical components of the present invention.

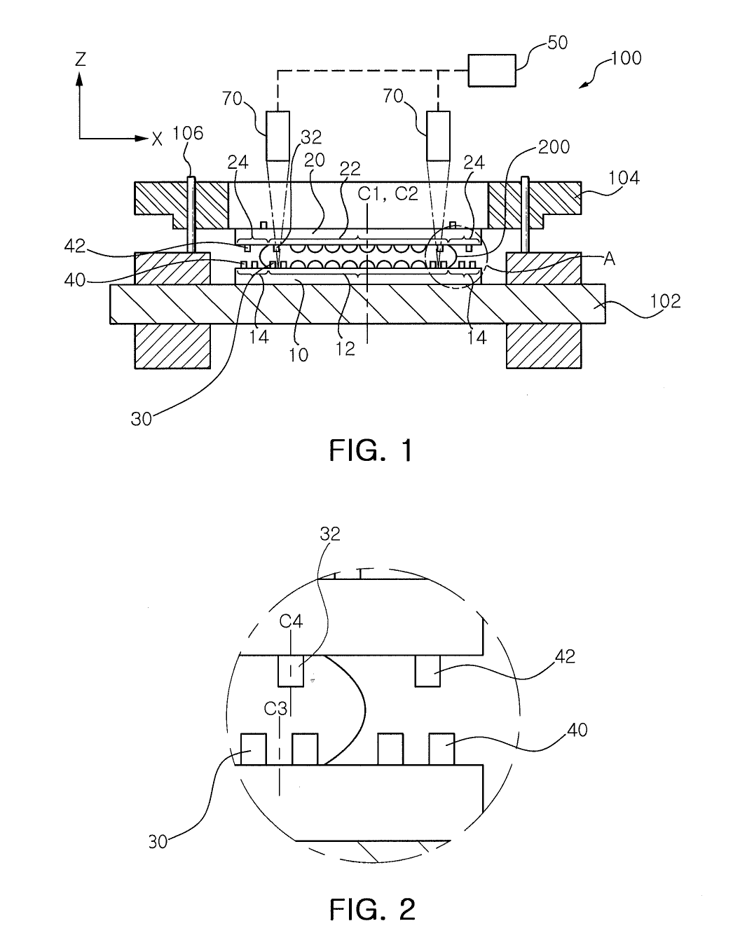

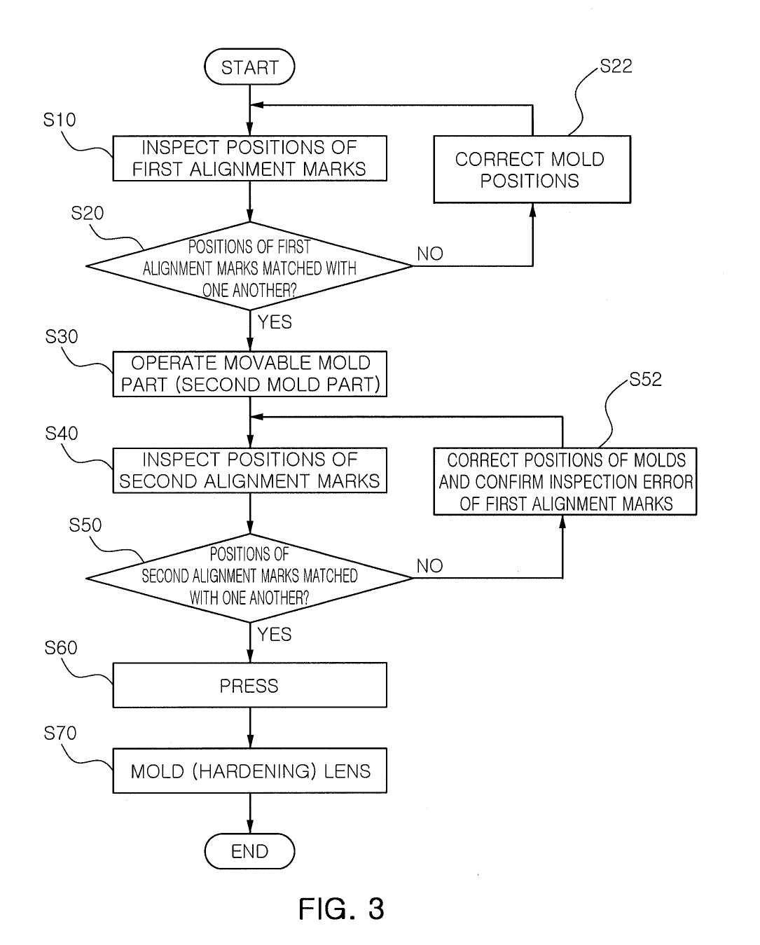

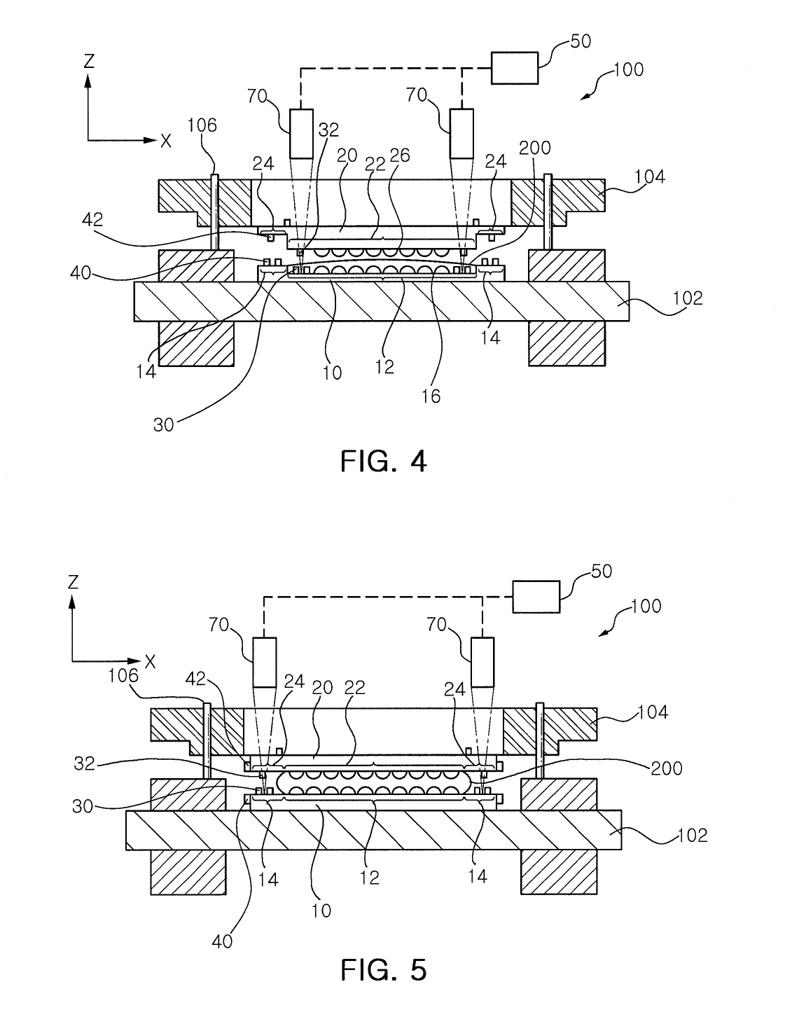

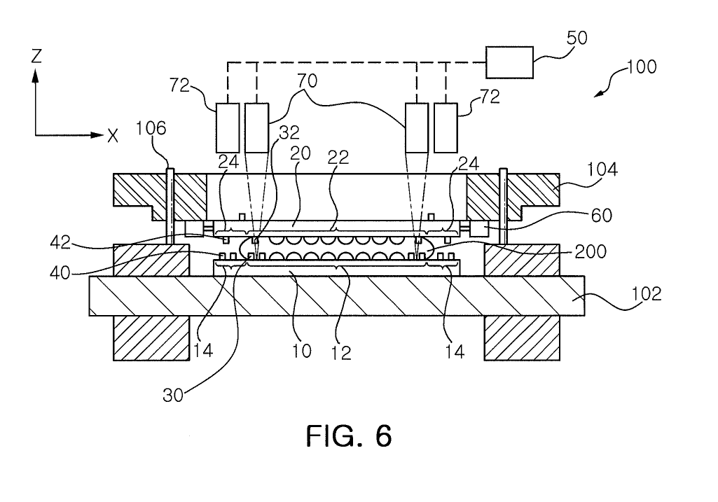

FIG. 1 is a cross-sectional view of a lens molding apparatus according to an embodiment of the present invention; FIG. 2 is an enlarged view of part A shown in FIG. 1; FIG. 3 is a flow chart for explaining a lens molding method using the lens molding apparatus shown in FIG. 1; FIG. 4 is a cross-sectional view of a lens molding apparatus according to another embodiment of the present invention; FIG. 5 is a cross-sectional view of a lens molding apparatus according to another embodiment of the present invention; and FIG. 6 is a cross-sectional view of a lens molding apparatus according to another embodiment of the present invention.

For reference, in the present invention, the expression “a first mold part 10 and a second mold part 20 are correctly aligned” means that an optical axis (C1) of a first lens molding part 12 is matched with an optical axis (C2) of a second lens molding part 22.

The lens molding apparatus 100 according to an embodiment of the present invention may include a first mold part 10, a second mold part 20, first alignment marks 30 and 32, second alignment marks 40 and 42, a controller 50, and a first sensor 70. The apparatus 100 may further include a first jig 102, a second jig 104, and a guiding member 106, selectively.

The first mold part 10 may be formed of glass, plastic, metal, or the like, and may include the first lens molding part 12 substantially molding a lens array and a first flat part 14 positioned at the edge of the first lens molding part 12. The first lens molding part 12 may mold a lens surface of the lens array through which an effective light passes and a flat surface of the lens array surrounding the lens surface. Here, the shape of the first lens molding part 12 (accurately, the shape of the portion of molding the lens surface) may be a convex shape or a concave shape depending on the shape of the lens to be molded, and may be a spherical shape or an aspherical shape. The first flat part 14 may be formed at the edge of the first lens molding part 12. The first flat part 14 may be utilized as a buffer space for preventing a lens molding material from flowing out during an alignment procedure.

The first mold part 10 constituted as above may be freely detached from or attached onto the first jig 102, and the fixed position thereof on the first jig 102 may be changed.

The second mold part 20 may be formed of glass, plastic, metal, or the like, and may include the second lens molding part 22 substantially molding the lens array and a second flat part 24 positioned around the edge of the second lens molding part 22. The second lens molding part 22 may mold the lens surface in the lens array through which an effective light passes, and the flat surface (or rib surface) of the lens array surrounding the lens surface. Here, the shape of the second lens molding part 22 (accurately, the shape of the portion of molding the lens surface) may be a convex shape or a concave shape depending on the shape of the lens to be molded, and may be a spherical shape or an aspherical shape. The second flat part 24 may be formed at the edge of the second lens molding part 22. The second flat part 24 may be utilized as a buffer space for preventing a lens molding material from flowing out during an alignment procedure.

The second mold part 20 constituted as above may be freely detached from or attached onto the second jig 104, and the fixed position thereof on the second jig 104 may be changed. Here, the second jig 104 may move toward the first jig 102 (in a Z-axis direction) by the guiding member 106.

The first alignment marks 30 and 32 may be formed on the first mold part 10 and the second mold part 20, respectively. The first alignment marks 30 and 32 may be formed on the first and second lens molding parts 12 and 22 or the first and second flat parts 14 and 24 in the first and second mold parts 10 and 20. The former case may have strengths in that the effective areas of the first and second lens molding parts 12 and 22 are relatively wide in the first and second mold parts 10 and 20, but the first alignment marks 30 and 32 may be easily encroached by the lens material. On the contrary to this, the latter case may have strengths in alignment of the first mold part 10 and the second mold part 20 since the possibility that the first alignment marks 30 and 32 are encroached by the lens material is relatively low although the effective areas of the lens molding parts 12 and 22 are relatively small in the first and second mold parts 10 and 20.

The first alignment marks 30 and 32 may be formed to have different shapes on the first mold part 10 and the second mold part 20, respectively. For example, the first alignment mark 30 having a groove may be formed in the first mold part 10, and the first alignment mark 32 having a protrusion corresponding to the groove may be formed on the second mold part 20. In addition, the first alignment marks 30 and 32 may have a predetermined reflectance. Therefore, when the first sensor 70 irradiates a predetermined wavelength of light, the first alignment marks 30 and 32 may reflect the corresponding wavelength of light.

Meanwhile, the first alignment marks 30 and 32 are formed adjacently to the first and second lens molding parts 12 and 22, and thus, may be covered with the lens material 200 at the time of molding the lens. In this case, the light irradiated to the first alignment marks 30 and 32 may not be normally reflected. Actually, the reflectance of the first alignment marks 30 and 32 is significantly similar to the reflectance of the lens material 200. Therefore, in the case in which the first alignment marks 30 and 32 are covered with the lens material 200, the first alignment marks 30 and 32 may be sensed to be matched with one another even in the case that the central axis (C3) of the first alignment mark 30 is not matched with the central axis (C4) of the first alignment mark 32.

Considering this, the second alignment marks 40 and 42 are further formed in the present invention. The second alignment marks 40 and 42 may be formed on the first mold part 10 and the second mold part 20, respectively. The second alignment marks 40 and 42 may be formed outside of the first alignment marks 30 and 32 on the first mold part 10 and the second mold part 20. Specifically, the second alignment marks 40 and 42 may be formed on the first and second flat parts 14 and 24. This structure is positioned in a region in which the second alignment marks 40 and 42 are not encroached by the lens material 200 such that a precise alignment of the first and second mold parts 10 and 20 may be achieved through the second alignment marks 40 and 42. Meanwhile, the second alignment marks 40 and 42 may be formed to have different shapes on the first mold part 10 and the second mold part 20, respectively, like the first alignment marks 30 and 32. For example, the second alignment mark 40 having a groove may be formed in the first mold part 10, and the second alignment mark 42 having a protrusion corresponding to the groove may be formed on the second mold part 20. In addition, the second alignment marks 40 and 42 may have a predetermined reflectance. Therefore, when the first sensor 70 irradiates a predetermined wavelength of light, the second alignment marks 40 and 42 may reflect the corresponding wavelength of light.

The controller 50 may determine the alignment state of the first and second mold parts 10 and 20 through the first and second alignment marks 30, 32, 40 and 42. For this, the controller 50 may be electrically connected to the first sensor 70. The controller 50 may determine whether the first and second mold parts 10 and 20 are accurately aligned through information of light reflected from the first alignment marks 30 and 32.

For example, the controller 50 may determine that the first mold part 10 and the second mold part 20 are accurately aligned when the shape of the reflected light corresponds to a predetermined shape. Contrary to this, the controller 50 may determine that the first mold part 10 and the second mold part 20 are not accurately aligned when the shape of the reflected light does not correspond to a predetermined shape. In addition, the controller 50 may let manager know whether the first and second mold parts 10 and 20 are accurately aligned through the information obtained from the first alignment marks 30 and 32. Also, the controller 50 may again determine alignment positions of the first and second mold parts 10 and 20 through information of the reflected light from the second alignment marks 40 and 42. That is, in the case in which the controller 50 determines that the first and second mold parts 10 and 20 are not accurately aligned through the information obtained from the second alignment marks 40 and 42 even in the case that the first and second mold parts 10 and 20 are determined to be accurately aligned by the first alignment marks 30 and 32, the controller 50 may let the manager know this condition. For example, the controller 50 may let the manager know the degree of mismatch in the alignment positions of the first and second mold parts 10 and 20 by using numerical values or drawings, and for implementing this, the present invention may further include a separate display unit (a monitor or the like).

The first sensor 70 may be installed on the second jig 104, and move in a horizontal direction (X-axis direction in FIG. 1). That is, the first sensor 70 may move in a horizontal direction, and may sense the first alignment marks 30 and 32 and the second alignment marks 40 and 42, selectively. The first sensor 70 may irradiate a predetermined wavelength of light, and may sense the corresponding wavelength of light that is reflected. The first sensor 70 may transmit the sensed reflected light information to the controller 50, and may be connected to the controller 50 for implementation thereof.

The lens molding apparatus 100 according to the present embodiment constituted as above may correct the alignment positions of the first and second mold parts 10 and 20 by re-sensing the alignment positions of the first and second mold parts 10 and 20 by the second alignment marks 40 and 42 that are not encroached upon by the lens material 200. Therefore, according to the present embodiment, a lens array including a plurality of lenses without a mismatch between optical axes may be molded.

Meanwhile, although not shown in the drawings, the jigs 102 and 104 may further include a clip or a vacuum adsorption unit serving as a coupling unit for respectively fixing the first and second mold parts 10 and 20. Also, the lens molding apparatus 100 may further include a moving unit for moving the second jig 104 or the second mold part 20 to the first jig 102 or the first mold part 10.

Hereinafter, a lens molding method by using the lens molding apparatus according to the present embodiment will be described with reference to FIGS. 2 and 3.

The molding procedure of the lens array using the lens molding apparatus may include the following operations.

### 1) Preparing Operation

In this operation, members necessary for the molding of lens are prepared. In the present operation, processes of preparing the first mold part 10 and the second mold part 20 corresponding to a lens array to be molded and respectively fixing the first mold part 10 and the second mold part 20 on the first jig 102 and the second jig 104 may be performed. In addition, a process of laying the lens material 200 for aligning the lens array on the first mold part 10 may be performed.

### 2) First Alignment Position Inspecting Operation and Mold Operating Operation (S10˜S30)

In the present operations, positions of the first mold part 10 and the second mold part 20 are matched with each other so as to be aligned. In the present operations, alignment states of the first mold part 10 and the second mold part 20, respectively fixed to the first jig 102 and the second jig 104 may be inspected. For example, the first sensor 70 may irradiate light toward the first alignment mark 30 of the first mold part 10 or the first alignment mark 32 of the second mold part 20, and transmit the reflected light to the controller 50. Then, the controller 50 may determine whether the first mold part 10 and the second mold part 20 are accurately aligned by comparing the shape of the reflected light with the predetermined shape or the pre-stored shape. Here, when the first mold part 10 and the second mold part 20 are accurately aligned, the central axis (C3) of the first alignment mark 30 formed on the first mold part 10 is matched with the central axis (C4) of the first alignment mark 32 formed on the second mold part 20. Hence, the clear reflected light respectively corresponding to the first alignment mark 30 of the first mold part 10 and the first alignment mark 32 of the second mold part 20 may be received in the first sensor 70. Contrary to this, when the first mold part 10 and the second mold part 20 are not accurately aligned, the central axis (C3) of the first alignment mark 30 formed on the first mold part 10 is not matched with the central axis (C4) of the first alignment mark 32 formed on the second mold part 20. Hence, only the reflected light corresponding to the first alignment mark 30 of the first mold part 10 or the first alignment mark 32 of the second mold part 20 may be received in the first sensor 70, or reflected light having an incomplete shape may be received therein. The controller 50 may determine whether the first mold part 10 and the second mold part 20 are accurately aligned by using this feature.

Meanwhile, when the controller 50 determines that the first mold part 10 and the second mold part 20 are not accurately aligned, the controller 50 may transmit a separate alarm signal (for example, an alarm sound or an alarm indication) to the manager. Then, through this, the manager may change a position of the first mold part 10 or the second mold part 20.

Through this procedure, when the first mold part 10 and the second mold part 20 are accurately aligned, a movable mold part (the second mold part 20 in the present embodiment) may be moved toward the first mold part 10. Here, the alignment states of the first mold part 10 and the second mold part 20 may be continuously confirmed by the first sensor 70 and the controller 50, and the second mold part 20 may be moved only to the height at which the second mold part 20 is contacted with the lens material 200.

### 3) Second Alignment Position Inspecting Operation and Correcting Operation (S40˜S52)

In the present operations, alignment positions of the first mold part 10 and the second mold part 20 are inspected through the second alignment marks 40 and 42, and then corrected. In the present operations, the first sensor 70 may inspect the alignment positions of the first and second mold parts 10 and 20 based on the second alignment marks 40 and 42. For example, the first sensor 70 may irradiate light toward the second alignment mark 40 of the first mold part 10 or the second alignment mark 42 of the second mold part 20, and transmit the reflected light to the controller 50. Then, the controller 50 may determine whether the first mold part 10 and the second mold part 20 are accurately aligned by comparing the shape of the reflected light with the predetermined shape or the pre-stored shape (since the alignment inspecting method of the first and second mold parts 10 and 20 through the second alignment marks 40 and 42 is the same as that through the first alignment marks 30 and 32, descriptions thereof will be omitted).

When the controller 50 determines that the first mold part 10 and the second mold part 20 are not accurately aligned through the second alignment marks 40 and 42, the controller 50 may transmit a separate alarm signal to the manager so that the manager may correct a mismatch therebetween. Here, when the controller 50 determines that the second alignment marks 40 and 42 are not matched with one another, even in the case that it determines that the first alignment marks 30 and 32 are matched with one another in the previous operation, the controller 50 may store the mismatch degree of the corresponding second alignment marks 40 and 42 as an offset value of the first alignment marks 30 and 32. Then, in the subsequent molding procedure, the match or mismatch of the first alignment marks 30 and 32 may be inspected and determined considering the corresponding offset value.

When the alignment positions of the first mold part 10 and the second mold part 20 are corrected by the manager, alignment states of the first mold part 10 and the second mold part 20 are again inspected through the second alignment marks 40 and 42. The inspection and correction procedures as detailed above may be repeatedly performed until the first mold part 10 and the second mold part 20 are accurately aligned (that is, the optical axis (C1) of the first mold part 10 is matched with the optical axis (C2) of the second mold part 20).

### 4) Lens Array Molding Operation (S60˜S70)

In the present operation, the lens material 200 undergoes the process in which the first mold part 10 and the second mold part 20 are matched with each other to be aligned, and then is hardened to thereby mold lenses of the lens array. In the present operation, the lens material 200 may be hardened by aligning the second mold part 20 with the first mold part 10 and applying a predetermined amount of heat and light thereto. Through this, the lens material 200 may be manufactured into lenses of a lens array so as to be commercialized.

In the present embodiment constituted by the above operations, the errors of the first alignment marks 30 and 32 may be corrected through the second alignment marks 40 and 42, and thus, the degree of molding precision of lenses in the lens array may be improved. Further, in the present embodiment, the error of the first alignment marks 30 and 32 recognized through the second alignment marks 40 and 42 may be set as an initial offset value, and thus, the same lenses among the lens arrays may be repeatedly and precisely molded.

Hereinafter, other embodiments of the present invention will be described. For reference, the same reference numerals will be used in the following embodiments to describe components the same as those described in the above-described embodiment. Thus, detailed descriptions of the components will be omitted.

### Another Embodiment

Another embodiment of the present invention will be descried with reference to FIG. 4. The lens molding apparatus according to the present embodiment may be differentiated from the above-described embodiment in view of the shape of the first mold part.

As described above, when the alignment marks 30, 32, 40, and 42 are encroached on by the lens material 200, they may not be recognized by the first sensor 70. In the present embodiment, a receiving region 16 is formed in the first mold part 10 and a protruding region 26 corresponding to the receiving region 16 is formed on the second mold part 20. Here, the first lens molding part 12 and the first alignment mark 30 may be formed on the receiving region 16, and the second lens molding part 22 and the first alignment mark 32 may be formed on the protruding region 26.

In this structure, the second alignment marks 40 and 42 are positioned to be higher than the lens material 200 as shown in FIG. 4, and thus, the second alignment marks 40 and 42 are not encroached on by the lens material 200. Hence, according to the present embodiment, alignment states of the first and second mold parts 10 and 20 through the second alignment marks 40 and 42 may be more precisely measured.

### Another Embodiment

Another embodiment of the present invention will be described with reference to FIG. 5. The lens molding apparatus according to the present embodiment may be differentiated from the above-described embodiments in view of the formation positions of the second alignment marks.

In the case in which the second alignment marks 40 and 42 are additively formed on the first and second mold parts 10 and 20, the area of effective molding part (that is, the lens molding parts 12 and 22) may be relatively reduced. Considering this, the second alignment marks 40 and 42 are formed on lateral surfaces of the first and second mold parts 10 and 20 in the present embodiment. Therefore, according to the present embodiment, the area of the effective molding part is relatively increased in the first and second mold parts 10 and 20, and thus, the production yield of the lens array may be raised.

### Another Embodiment

Another embodiment of the present invention will be descried with reference to FIG. 6. A lens molding apparatus according to the present embodiment may be differentiated from the above-described embodiments in that a position corrector 60 and a second sensor 72 are further included.

In the present embodiment, alignment states of the first and second mold parts 10 and 20 through the first alignment marks 30 and 32 and the second alignment marks 40 and 42 are continuously inspected, and thus, the second sensor 72 for only inspecting the second alignment marks 40 and 42 may be further included.

In addition, in the present embodiment, the position corrector 60 for moving the second mold part 20 in an X-axis direction may be further installed on the second jig 104 so that the position of the second mold part 20 with respect to the first mold part 10 is promptly corrected. Here, since the alignment error of the first mold part 10 and the second mold part 20 is generally about several mm, the position corrector 60 may have a slight amount of movement.

As set forth above, according to embodiments of the present invention, the alignment position of the mold is inspected through two or more different alignment marks, and thus, the degree of molding precision of the lens may be improved.

While the present invention has been shown and described in connection with the embodiments, it will be apparent to those skilled in the art that modifications and variations may be made without departing from the spirit and scope of the invention as defined by the appended claims.

What is claimed is:

1. A lens molding apparatus, the apparatus comprising:
a first mold part and a second mold part molding a lens array;
first alignment marks respectively formed on the first mold part and the second mold part;
second alignment marks respectively formed on the first mold part and the second mold part and positioned outside of the first alignment marks; and
a controller sensing an alignment error of the first alignment marks based on the second alignment marks and correcting a relative position of the second mold part with respect to the first mold part in proportion to the magnitude of the sensed alignment error.

2. The apparatus of claim 1, wherein the first mold part or the second mold part has a receiving region in which a lens material for forming the lens array is received.

3. The apparatus of claim 2, wherein the second alignment marks are formed outside of the receiving region to prevent an encroachment thereon by the lens material.

4. The apparatus of claim 1, wherein the second alignment marks are formed on lateral surfaces of the first mold part and the second mold part.

5. The apparatus of claim 1, further comprising a position corrector moving the first mold part or the second mold part in response to a control signal from the controller.

6. The apparatus of claim 1, further comprising a first sensor and a second sensor sensing a match or mismatch between the first alignment marks and the second alignment marks, respectively.

7. A lens molding method, the method comprising:
allowing a first mold part and a second mold part to be aligned with each other and thus allowing first alignment marks respectively formed on the first mold part and the second mold part to be matched with one another;
inspecting whether the second alignment marks respectively formed on the first mold part and the second mold part are matched with one another, and then measuring the degree of mismatch (error) of the second alignment marks;
correcting an alignment position of the first mold part or the second mold part in proportion to the magnitude of the measured error; and
re-aligning the first mold part and the second mold part and hardening a lens material.
